(19) United States
(12) Patent Application Publication
(10) Pub. No.: US 2016/0189483 A1
(43) Pub. Date: Jun. 30, 2016

(54) APPARATUS, SYSTEMS AND METHODS FOR PROMOTING AND PLACING PARI-MUTUEL WAGERS

(71) Applicant: XERAFLOP TECHNOLOGIES INC., Vancouver (CA)

(72) Inventor: Glenn Stacey BALLMAN, Calgary (CA)

(21) Appl. No.: 14/819,243

(22) Filed: Aug. 5, 2015

Related U.S. Application Data
(63) Continuation of application No. PCT/CA2014/050076, filed on Feb. 6, 2014.
(60) Provisional application No. 61/761,595, filed on Feb. 6, 2013.
(60) Provisional application No. 61/761,594, filed on Feb. 6, 2013.

(51) Int. Cl. G07F 17/32; G06Q 50/34

(52) U.S. Cl. CPC G07F 17/3258; G06Q 50/34

(57) ABSTRACT

Methods and apparatus are provided for placing pari-mutuel wagers. One such method comprises: providing a user with an opportunity to place a pari-mutuel wager in which one or more criteria associated with the pari-mutuel wager are selected on behalf of the user; generating a ranking of events from among a plurality of potential events based on one or more ranking criteria associated with each event; presenting to the user one or more potential wagers based on one or more outcomes of the one or more top-ranked events from the ranking, a number of the one or more top-ranked events less than a number of the plurality of potential events; and permitting the user to place the pari-mutuel wager based at least in part on an outcome of one of only the one or more top-ranked events.

### RELATED APPLICATIONS

This application is continuation of Patent Cooperation Treaty application No. PCT/CA2014/050076 filed 6 Feb. 2014 which claims the benefit of the priority of U.S. application No. 61/761,594 filed 6 Feb. 2013 and U.S. application No. 61/761,595 filed 6 Feb. 2013. All of the applications referred to in this paragraph are hereby incorporated herein by reference.

### TECHNICAL FIELD

This application relates to pari-mutuel wagering. Particular embodiments provide apparatus, systems and methods for promoting and/or placing pari-mutuel wagers.

### BACKGROUND

A common form of gambling involves a so-called “pari-mutuel” system, where: all wagers of a particular type are placed together in a pool; taxes and a “house-take” (or commission) are removed from the pool; and the remaining amount of the pool is then paid out to the winners. Together, the house take and taxes (and any other amounts removed from the pool prior to payout) may be referred to as the “takeout”. Unlike fixed-odds wagering (where the odds of a wager are known in advance), pari-mutuel wagering involves calculating the payoff odds after the pool is closed (and after removal of the takeout). Pari-mutuel wagering is common in horse racing and greyhound racing, although it is not limited to these types of wagering.

In a simplified example of pari-mutuel wagering, consider a horse race involving eight horses where the only type of wager is a win wager—i.e. a wager on the horse that will place first in the race. Such a race has eight possible outcomes—i.e. each of the eight horses could win. Assume that at the time betting closes (e.g. right before the race), the wagers on the various horses to win were as shown in Table 1 below.

TABLE 1
Example Pari-mutuel Horse Race

| Horse to Win | Wager Amounts |
|---|---|
| 1 | $500 |
| 2 | $150 |
| 3 | $200 |
| 4 | $125 |
| 5 | $275 |
| 6 | $200 |
| 7 | $350 |
| 8 | $150 |

In the Table 1 example, the total pool of money (often referred to as the “handle”) is the sum of the amounts in the second column—i.e. $1950. Assuming that the takeout rate is 20%, the pool will be reduced by 0.20*$1950=$390, leaving total available winnings of $1950−$390=$1560. Now assume that the winning horse was horse number 6. So the remaining pool is distributed to those who wagered on horse number 6 in the amount of $1560/$200≈$7.80 for every $1 wagered. Since this $7.80 payout includes the original $1 wagered, the actual profit from a $1 wager on horse number 6 is $6.80 and the odds of a bet placed on horse number 6 are 6.8 to 1 (fractional odds) or $7.80 (decimal odds).

Based on the above example, it will be appreciated that the exact odds of a particular wager are subject to change while wagers are still being accepted on the race. However, the odds at any particular instant in time may be calculated. These instantaneous odds are only approximate, because in the time required for calculation, additional wagers may be placed, thereby changing the odds. For example, in the case of the Table 1 example at the instant that the Table 1 wagers are accurate, the approximate fractional odds for the Table 1 event may be calculated as shown in Table 2.

TABLE 1
Example Instantaneous Odds for Table 1 Race

| Horse to Win | Payout Odds (Fractional) |
|---|---|
| 1 | $2.12/1 |
| 2 | $9.4/1 |
| 3 | $6.8/1 |
| 4 | $11.5/1 |
| 5 | $4.7/1 |
| 6 | $6.8/1 |
| 7 | $3.6/1 |
| 8 | $9.4/1 |

The ability to calculate approximate instantaneous odds on horse races and greyhound races led to the development of devices known as “totalizators” or, more commonly, “totes”. In their most basic form, totes can calculate the approximate instantaneous payoff odds of a race. The development of totes has led to a corresponding proliferation of “off-track” betting (also known as “OTB”) facilities where wagers can be placed on race events from locations away from the racing track. Modern totes comprise computers running specialized software (e.g. Autotote™ or the like). Modern totes are networked to be able to communicate with one another from distributed OTB locations and to thereby obtain approximate instantaneous odds which account for wagers placed from other OTB locations. Modern totes can also accept wagers and issue corresponding tickets which evidence the wagers placed. Typically, a bettor would communicate their wager to a teller at an OTB, who would take the bettors money, enter the wager into the tote and issue a corresponding ticket.

Current OTB facilities have a number of drawbacks which can make it undesirable for bettors to place wagers at an OTB. By way of non-limiting example: OTBs receive satellite video feeds from various racetracks, but have a limited number of video screens, which can create a drawback for bettors when they cannot locate a display screen which is showing a race on which they wagered or when races from various tracks are temporally overlapping; typically, at an OTB, sound must be turned off on all of the displays, because there is no correspondence between bettors and displays and there are many displays in which various users may or may not be interested; odds received by satellite and displayed on video screens can be delayed by several seconds over instantaneous odds; a bettor may have to leave their seat to interact with a teller each time that they make a bet or to view a race on a display screen that may be at another location in the facility; wagers are generally placed anonymously which can preclude the ability to customize the entertainment experience and/or others. The payback to the OTB operators comes from the takeout associated with wagers placed at their OTB facilities. Consequently, if bettors are not betting at an OTB facility, the income of the OTB operator will be correspondingly reduced.

There is a general desire to improve the OTB wagering experience for bettors, for OTB operators and/or for other parties involved in pari-mutuel gambling events, such as horse races, greyhound races and/or the like.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention provide systems, methods and/or apparatus for recommending pari-mutuel automatic or semi-automatic wagers where the systems, methods and/or apparatus select one or more wagering parameters on behalf of the bettor. Wagers are recommended to the bettor which maximize (or provide relatively high) net takeout rates for the house.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A and 1B (collectively, FIG. 1) are isometric views of a wagering apparatus 10 according to a particular embodiment with its cabinet door closed (FIG. 1A) and its cabinet door open (FIG. 1B).

FIG. 2 is a schematic view of a number of the functional components of the FIG. 1 apparatus.

FIG. 3 is a schematic illustration of an exemplary wagering method according to a particular embodiment.

FIG. 4 is a schematic illustration of an exemplary wagering method according to a particular embodiment.

FIG. 5 is a schematic illustration of the takeout, payout and handle of an exemplary pari-mutuel horse race.

FIG. 6 is a schematic illustration of an exemplary method for selecting a race according to a particular embodiment.

FIG. 7 is a schematic illustration of an exemplary method for generating a ranked list of races according to a particular embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

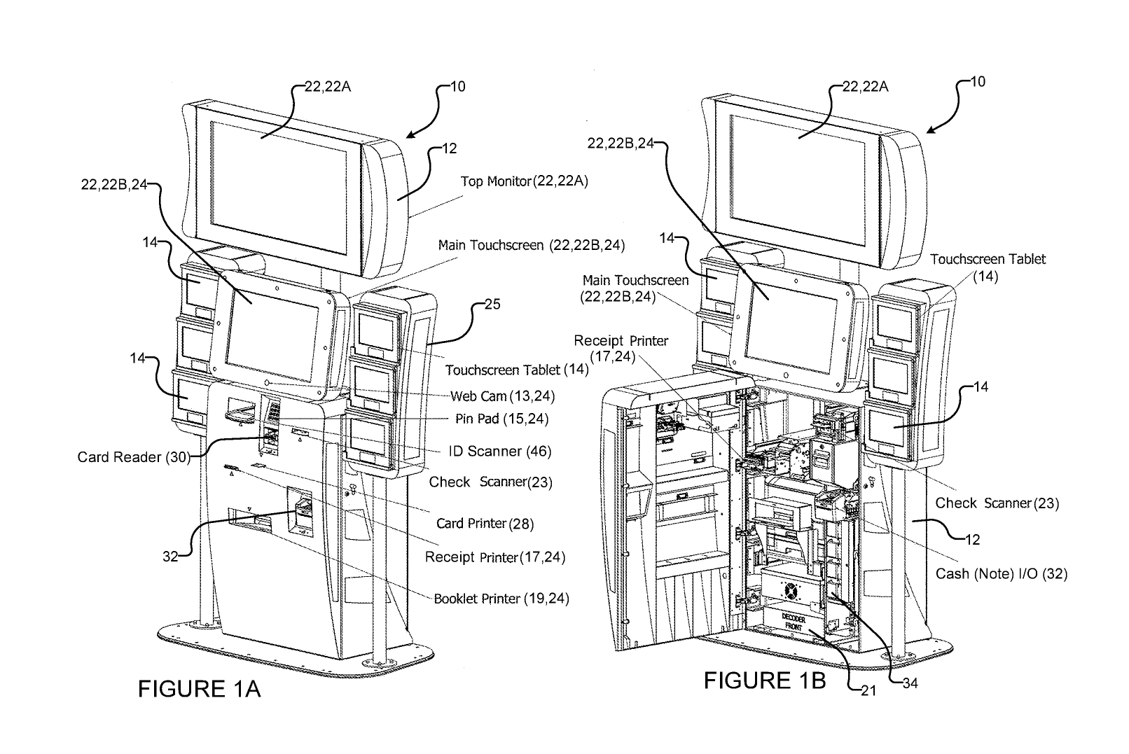

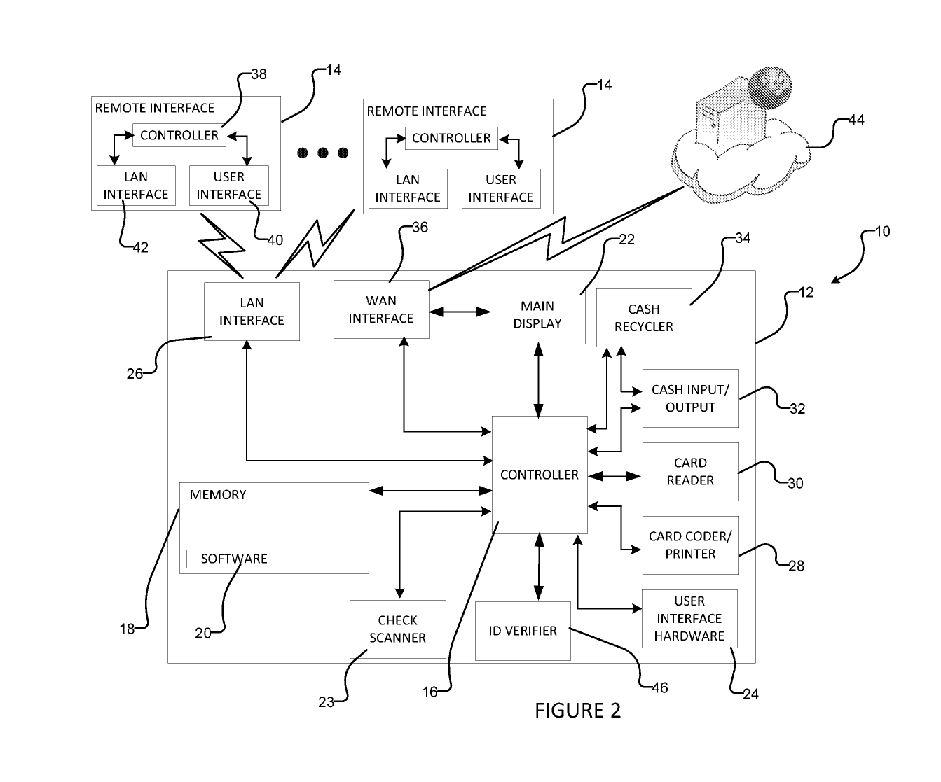

FIG. 1 is an isometric view of a wagering apparatus 10 according to a particular embodiment. FIG. 2 is a schematic view showing the functional components of wagering apparatus 10. Wagering apparatus 10 comprises a main wagering apparatus 12 and, optionally, one or more remote interface units 14. Wagering apparatus 12 is controlled by a controller 16. Controller 16 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 16 may have access to software instructions 20 which may be stored in computer-readable memory 18 accessible to controller 16 and/or in computer-readable memory (not shown) that is integral to controller 16. Controller 16 may be configured to read and execute software instructions 20 and, when executed by controller 16, such software 20 may cause controller 16 to implement one or more of the methods described herein.

Controller 16 may interact with and control a number of the other functional components of wagering apparatus 12. More particularly, controller 16 may control a display 22 and other user interface hardware 24 for interacting with user(s)/bettor(s). Display 22 and/or user interface hardware 24 may be used (by controller 16) to implement a graphical user interface (GUI). By way of non-limiting example, display 22 may comprise a video display which may optionally have “touch screen” functionality for accepting user input (e.g. by tapping a screen of display 22 and/or using other gestures where a user contacts the screen with their body, with a suitably configured stylus and/or the like). In the FIG. 1 embodiment, display 22 incorporates a two-part display 22 which comprises a large-screen display 22A and a touch-screen display 22B. Because of its touch-screen capability, touch-screen display 22B also provides part of user interface hardware 24. By way of non-limiting example, other user interface hardware 24 may comprise a keypad, a keyboard, a selector device (e.g. a mouse, trackpad or similar pointing device) and/or the like. In the FIG. 1 embodiment, user interface hardware 24 comprises touch-screen display 22B, camera 13, keypad 15, receipt printer 17 and booklet (e.g. race information) printer 19. In some embodiments, user interface hardware 24 may comprise fewer components, additional components or other components suitable for interacting with a user in the manner described herein. In addition to its functionality for implementing the GUI, display 22 (e.g. one or both of large-screen display 22A and touch-screen display 22B) may also be used to display satellite feeds (e.g. of horse race events or the like) and/or signals which may be received from network 44 via wide area network (WAN) interface 36. Such video signals may be decoded (e.g. by decoder 21) for display on display 22. In some embodiments, main apparatus 12 comprises a plurality of large-screen displays 22A. In some embodiments, main apparatus 12 is in direct or indirect communication with other external displays (not shown) for rendering video content.

In the illustrated embodiment, wagering apparatus 12 comprises LAN interface 26 for communication with a local area network (e.g. a local network comprising main apparatus 12, remote interface units 14 and/or other suitable devices) and a wide area network (WAN) interface 36 for interacting with a WAN network 44, such as the internet or the like. More particularly and as explained in more detail below, controller 16 can communicate (via WAN interface 36) through the internet 44 to place wagers on various races (or other pari-mutuel wagering events), to connect to live video feeds of various races, to interact with stored value accounts of various users and/or the like. In some embodiments, wagering apparatus 10 and/or the venue in which main wagering apparatus 12 is deployed may comprise a WAN interface 36 (e.g. a suitable router and internet access point) that is not provided as a part of main wagering apparatus 12, but rather is separate from main wagering apparatus 12. In such embodiments, main wagering apparatus 12 may communicate with WAN network 44 via LAN interface 26 and the external WAN interface 36.

Wagering apparatus 12 may also comprise other hardware which may be controlled by controller 16 for interacting with user(s). In the illustrated embodiment, such user-interaction hardware comprises a card coder/printer 28, a card reader 30, a cash input/output 32, an identification verification unit 46 and a check scanner 23. In some embodiments, wagering apparatus 12 may comprise additional or alternative user-interaction hardware. In some embodiments, wagering apparatus 12 may not contain all of card coder/printer 28, card reader 30, cash input/output 32, identification verification unit 46 and check scanner 23.

Card coder/printer 28 may be used to encode information on user-ID cards. Examples of information that can be encoded onto a card by card coder/printer 28 include a user account ID, which enables a user to create, access and otherwise interact with a stored value account. Such stored value accounts may comprise online stored value accounts provided by third party services and may be accessed via WAN interface 36 and network 44 (e.g. the internet). Such stored value accounts enable secure money transfers (e.g. electronic funds transfers (EFT), automated clearing house (ACH) transfers and/or the like) via network 44. In some embodiments, a user-ID card is not necessary for a user to interact with their stored value account via wagering apparatus 10. For example, a user may manually enter a user ID and password using user interface hardware 24 to interact with their stored value account via wagering apparatus 10. In some embodiments, a user may additionally or alternatively enter a user ID and password (or other suitable login criteria) using a remote interface unit 14 (described in more detail below). Wagering apparatus 10 (under the control of controller 16) is configured to accept wagers by withdrawing money from stored value accounts accessed by users via WAN interface 36 and network 44. In some embodiments, card coder/printer 28 could additionally or alternatively be used to encode an indication of the amount of stored value in an account associated with a corresponding card, such that a user's card may act in a manner similar to stored value card or credit card. In some embodiments, card coder/printer 28 may additionally be able to read information that it (or other similar card encoder/printers) have encoded onto users' cards.

Cash input/output 32 may be used to accept cash from user(s) as input and to output cash to user(s) as output. For example, cash received via cash input 32 may be deposited (via WAN interface 36 and network 44) into a user's online stored value account and subsequently used for wagering. Additionally or alternatively, cash received via cash input 32 may be directly used for wagering. Cash received into apparatus 12 via cash input/output 32 can be provided to cash recycler 34. Cash recycler 34 may scan received cash to determine the denominations of received notes and (optionally) their serial numbers. Cash recycler 34 may also sort the various different note denominations for storage into corresponding receptacles. If a user wins, their winnings may be deposited (via WAN interface 36 and network 44) into their online stored value account. If the user chooses to receive cash winnings, then the user may make this indication known to apparatus 10 (e.g. via user interface hardware 24) and controller 16 may cause a withdrawal from the user's online stored value account and cause cash to be output from apparatus 10 (i.e. from cash recycler 34) via cash input/output 32.

Card reader 30 may be capable of reading credit cards, bank cards and/or the like and, with the possible assistance of controller 16, conducting transactions involving such cards (e.g. via WAN interface 36 and network 44). For example, card reader 30 may be able to withdraw an amount from a user's credit card and to deposit a corresponding amount into a user's stored value account. Similarly, in some embodiments, card reader 30 may be able to withdraw an amount from a user's stored value account and to deposit a corresponding amount onto a user's credit card. In some embodiments, card reader 30 also functions to read the cards encoded by card encoder/printer 28. In some embodiments, card encoder/printer 28, check scanner 23 and/or cash input/output 32 may also function as a card reader 30.

In some embodiments (e.g. where required in a particular jurisdiction or otherwise desirable), identification verifier 46 can be used to verify the identity of a user. By way of non-limiting example, identification verifier 46 may scan a piece of a user's identification and may use the scanned image to verify the user's age. In some embodiments, identification verifier 46 can include components for verifying the legitimacy of a piece of identification. For example, identification verifier 46 can include optical components (and suitable hardware and software configuration) for determining the type of plastic or paper used in a piece of identification and/or for locating authentication indicia to verify that the piece of identification is legitimate. In some embodiments, identification verifier 46 may comprise a camera 13, which may record an image of the user's face. This image may be saved in association with the user's account (e.g. for security procedures, auditing records and/or the like) and may be used as part of the identification verification procedure (e.g. using suitable facial recognition software and/or the like).

In the illustrated embodiment, apparatus 10 also includes an optional check scanner 23. Check scanner 23 may permit apparatus 10 to receive payment in the form of checks and may facilitate so-called “daylight loans” or the like where third party checks made out to a user may be received as input funds. Check scanner 23 may include suitable security and/or verification components for verifying the legitimacy of received checks.

In the illustrated embodiment, apparatus 10 comprises additional lights 25 which may be used to attract potential users to apparatus 10. To attract potential users, apparatus 10 may also play back audio and/or video associated with events (e.g. horse races) on which pari-mutuel wagers may be placed. Such video/audio may be shown/played back on display 22, on remote interface units 14 and/or on other displays or devices (e.g. on television screens in a bar). For example, apparatus 10 may show video and/or playback audio with shouting jockeys, pounding hooves, cheering fans and the like

Apparatus 10 may be installed in a traditional OTB venue, such as a casino and/or the like, for example. Apparatus 10 may additionally or alternatively be installed in social or entertainment venue (such as a bar, restaurant or the like) and/or any other suitable venue, including those which have social and/or entertainment facilities other than merely wagering. For the remainder of this description, it will be assumed, without loss of generality, that wagering apparatus 10 is located in a bar.

In operation, a patron of the bar may decide that they could have some fun if they placed a wager on a an event (e.g. a horse race or other pari-mutuel event) via wagering apparatus 10. The first time that a user without an existing stored value account interacts with apparatus 10, the user may interact with apparatus 10 (via user interface hardware 24) to create a stored value account. Creation of the stored value account may optionally involve the user presenting their identification to be verified by identification verifier 46. Alternatively, or in addition, the user may create a stored value account inline prior to (or while) interacting with apparatus 10. Once the account is created, card coder/printer 28 may create a user account ID card for the user which may be output to the user at that time. If the user created an account online, they may receive a user account ID card when they first log in to apparatus 10. The user can then fund the account using a credit card (or the like) inserted into card reader 30, cash inserted into cash input/output 32, a check inserted into check scanner 23, online fund transfer and/or the like. In some embodiments, users can fund their accounts with the human employees of the venue in which apparatus 10 is located, who may use a different system (not shown) to record the funding of the user's account (e.g. to increase the available balance of the user's stored value account). Once the account is created and funded, the user is in a position to place a wager.

It will be appreciated that creating a stored value account may only be required the first time that a user who has not previously created an account interacts with apparatus 10. A user may create a stored value account on one apparatus 10 and then place wagers using a different apparatus 10 and/or a remote interface unit 14 which may be at the same venue or at a different venue. The second and subsequent time(s) that a user interacts with apparatus 10 (or a similar apparatus 10 or a remote interface unit 14), the user may be able to use their user ID card (via card reader 30 or card coder/printer 28) to login to their account or may otherwise login to their account via user interface hardware 24 (or user interface 40 of remote interface unit 14), for example by providing a username and password. Provided that the account is funded, the user will be in a position to place a wager after logging in to their existing account. Depending on any local regulatory requirements, in some embodiments, a user may be required to verify their identification (via identification verifier 46) each time that they interact with apparatus 10.

In some embodiments, it may be desirable to provide multiple levels of stored value accounts. For example, some credit card companies (or similar financial institutions) do not permit use of their cards directly for wagering. In such cases, a user may create a first “gift card” stored value account which can be funded as discussed above (but which is not used directly for wagering) and then a second “wagering” stored value account which can be funded indirectly with funds from the first gift card stored value account (and which can be used directly for wagering).

The GUI of apparatus 12 may enable and optionally guide the user to select the particulars of a pari-mutuel wager. In cases where the event being wagered on is a horse race, a greyhound race, or the like, such wager particulars may include, without limitation: the track at which the race is being run, the particular race at the track, the amount of the wager and the type of the wager. As is well known to those familiar with horse racing, there are a large variety of bet types. Such bet types include: single race bets, such as (without limitation): win, place, show, exacta, trifecta, superfecta, duet and/or the like; and multi-race bets, such as (without limitation): double, triple, quadrella, sweep and/or the like. The GUI of apparatus 12 may display information (e.g. textually, audibly and/or graphically) about various races and/or wagers, handicapping strategies and/or the like. By way of non-limiting example, such information could include: constantly increasing pool sizes, instantaneous approximate odds, risk levels against payout potential, reports indicating the user's handicapping rates of success, statistical tools and tips to help the user become a better handicapper, information that might be useful to help a user identify handicapping opportunities that meet their user-specific handicapping criteria and/or the like.

When the user submits their wager, the amount of the wager is withdrawn from their stored value account and recorded by apparatus 10 (e.g. by controller 16). These wagered amounts may then become the property of the “house”—e.g. the proprietor of wagering apparatus 10, the proprietor of the venue in which apparatus 10 is located and/or the like. To the extent that the house does not administer the stored value account service, there may be a need for reconciliation between the accounts of the house and the stored value account service so that the stored value account service can pay the wagered amounts to the house. Additionally or alternatively, the house may maintain an account with the stored value account service into which wagered amounts may be credited. This reconciliation can happen in real time (e.g. as soon as the wagered amounts are debited from the user's stored value account) or at discrete times (e.g. daily, weekly or monthly). From time to time (e.g. daily, weekly or monthly) a pari-mutuel wagering oversight body (e.g. CHRIMS Inc. and/or the like) may request payment of these wagered amounts from the house and these wagered amounts will be transferred from the house to the oversight body. Such transfers may be effected by EFT, ACH transfer and/or the like. In some embodiments, such transfers from the house to the oversight body may happen in real time. From time to time (e.g. daily, weekly or monthly), the oversight body may then remit these wagered funds to the various stakeholders (e.g. race tracks, government bodies, content providers, winners and/or the like) in the form of takeout or winnings. In some embodiments, such transfers from the oversight body to the various stakeholders may happen in real time.

When the user submits their wager, controller 16 may access a video feed (via satellite, via network 44 or otherwise) to display the corresponding race(s) on display 22. In some embodiments, wagering apparatus 10 can be in communication with one or more other displays (not shown) in the bar in which apparatus 10 is located. In such embodiments, controller 16 may cause the video feed of the race(s) on which the user has wagered to be displayed on one or more of such other display(s). Controller 16 may be configured to cause display 22 (or some other aspect of its user interface) to direct the user to one of one or more other displays that are displaying or will display the race(s) on which the user has wagered. Additionally or alternatively, controller 16 may allow a user to select (via user interface hardware 24) one or more available displays on which to display such race(s). For example, controller 16 may direct a display near the user's table to display a race on which the user has wagered. Still other techniques may be used to select display(s) on which the race(s) that a user has wagered may be displayed.

If the race is run and the user loses, then no funds are deposited in the user's stored value account in respect of the lost wager. If the user wins, controller 16 records the user's winnings and makes the winnings available in the user's stored value account. Such winnings may be paid by the house. To the extent that the house does not administer the user's stored value account service, there may be a need for reconciliation between the accounts of the house and the stored value account service, so that the house can pay the winnings to the stored value account service. Additionally or alternatively, the house may maintain an account with the stored value account service which can be debited to pay the winnings to the stored value account service. This reconciliation can happen in real time (e.g. as soon as the winnings are placed into the user's stored value account) or at discrete times (e.g. daily, weekly or monthly). As mentioned above, from time to time (e.g. daily, weekly or monthly), an oversight body may transfer to the house its share of the takeout based on wagers placed through the house together with any winnings on wagers placed through the house.

If a user wants to cash out, they can withdraw the funds from their stored value account. Otherwise, some or all of the funds can be left in the account for subsequent wagering. Cash may be withdrawn, for example, from cash input/output 32 and/or from the house (e.g. by receiving cash from an employee who then debits the user's stored value account). Withdrawal of funds may also, or alternatively, occur via online fund transfer, deposit onto a debit/credit card, issuance of a check and/or by other means.

In the illustrated embodiment, wagering apparatus 10 comprises one or more optional remote interface units 14. Remote interface units 14 provide some of the functionality of main apparatus 12 and permit users to interact with wagering apparatus 10 to place wagers from remote locations (e.g. from their tables at a bar). Remote interface units 14 may be implemented, for example, by suitably configured tablet computing devices, suitably configured touch screen computing devices, suitably configured mobile phones and/or the like. In the illustrated embodiment, remote interface devices 14 are provided by the house. This is not necessary, however. In some embodiments, remote interface devices 14 may be embodied by the user's own device—e.g. suitably configured tablet computing devices, mobile phones and/or the like which may run suitable software application(s) and/or access suitable website(s). Each remote interface unit 14 comprises its own controller 38. Controller 38 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 38 may have access to software instructions (not shown) which may be stored in computer-readable memory (not shown) accessible to, and/or integral to, controller 38. In some embodiments, controller 38 may have access to software instructions 20 stored by main apparatus 12. Controller 38 may be configured to read and execute such software instructions to thereby implement one or more of the methods described herein.

Remote interface unit 14 comprises a user interface 40 which may include a display and suitable user input devices (e.g. a touch screen display, a keyboard, a pointing device and/or the like) to provide a graphical user interface (GUI). The GUI and display of remote interface unit 14 may be similar to the GUI and display 22 of main apparatus 12 and may provide the same or similar functionality. In the illustrated embodiment, remote interface unit 14 comprises a local area network (LAN) interface 42 for communication with main apparatus 12 (via a corresponding LAN interface 26 in main apparatus 12) and/or with other remote interface units 14 (e.g. to send messages between users of remote interface units 14). Remote interface unit 14 may communicate with WAN 44 (e.g. the internet) via the WAN interface 36 of apparatus 10. In some embodiments, remote interface unit 14 may additionally or alternatively comprise a WAN interface of its own (not shown) for communication to WAN 44 (e.g. the internet). A user can use remote interface unit 14 to place wagers and/or to perform other functions, such as (for example) streaming video of a race on which the user has wagered, performing account management transferring funds and so on. Such wagers may be communicated from remote interface unit 14 to main apparatus 12 through LAN interfaces 42, 26, whereafter it can be treated by main apparatus 12 like any other wager described herein, or, if remote interface unit 14 has its own WAN interface such wager may be placed directly via WAN 44 by remote interface unit 14. As discussed above, in some embodiments WAN interface 36 is not a part of main apparatus 12, but is instead an external WAN interface 36 (e.g. a suitable router and wireless access point). In such embodiments, remote interface units 14 can interact with WAN 44 (independently of main apparatus 12) to place wagers and/or to provide other functionality similar to that of apparatus 12 described herein. Video feeds (e.g. satellite or internet) procured by main apparatus 12 can also be communicated to remote interface unit 14 via LAN interfaces 26, 42 or may be procured directly by remote interface unit 14 from WAN 44.

A user may be able to login to their stored value accounts via remote interface unit 14 using user interface 40. In some embodiments, a user ID card or identification verification may be required for a user to login; in such embodiments, a user may need to login at main apparatus 12. A user may login to main apparatus 12 to “sign out” (e.g. acquire temporary use or possession of) a remote interface unit 14. In some embodiments, users can “sign out” a remote interface unit 14 from human employees of the venue in which apparatus 10 is located. Similarly, a user may (but need not necessarily) interact with main apparatus 12 to fund their account via cash input/output 32 or card reader 30 before signing out and using remote interface unit 14. In some embodiments, users can fund their accounts directly using remote interface unit 14 and/or with the human employees of the venue in which apparatus 10 is located, who may use a different system (not shown) to record the funding of the user's account. A user may login to apparatus 10 at main apparatus 12 prior to signing out a remote interface unit 14 and/or on remote interface unit 14 after unit 14 is signed out. Once signed out, a user may interact with remote interface unit 14 which may provide functionality similar to that of main apparatus 12 described herein.

As shown in FIG. 1, prior to being signed out, remote interface units 14 may be mounted to main apparatus 12. Remote interface units 14 may be locked to main apparatus 12 by suitable electrically controlled locking mechanisms (not shown), such as solenoid-actuated locks and/or the like. Controller 16 may cause a remote interface unit 14 to be unlocked when it is properly signed out by a user. A deposit may be collected from (or held in) the user's account to encourage the user to return remote interface unit 14. In some embodiments, remote interface units 14 may comprise proximity sensors, GPS sensors, RFID tags and/or the like which may activate alarms if the remote interface units 14 is moved too far from main apparatus 12.

In some embodiments, remote interface units 14 may rented (e.g. by the hour or by the minute). In such embodiments, main apparatus 12 may be configured to detect (e.g. with suitable detectors or the like and/or suitable interaction via LAN interfaces 26, 42) when a remote interface unit 14 is removed from its mount on apparatus 12 and when the remote interface unit 14 is returned to its mount. The user's stored value account may then be debited according to the amount of time that remote interface unit 14 was away from its mount. The user's deposit may also be returned (or freed) when remote interface unit is detected as being returned. In some embodiments, remote interface units 14 may be “docked” to suitable mounts at locations away from main apparatus 12—e.g. at mounts located on tables, on bar tops, on the floor in front of a large screen display and/or the like. In some such embodiments, remote interface units 14 may be activated when they are docked to such mounts and de-activated otherwise.

In some embodiments, main apparatus 12 is not necessary and apparatus 10 (and corresponding systems and methods) may be implemented using only remote interface units 14. In some such embodiments, remote interface units 14 may be provided with some of the hardware and/or functionality of main apparatus 12. By way of non-limiting example, remote interface units 14 may be provided with card readers similar to card reader 30 described above to permit a user to fund their account using remote interface unit 14. In some embodiments that comprise only remote interface units 14, some functionalities of main apparatus 12 that are not provided directly by remote interface units 14 may be provided in part by other systems and/or the employees of the venue in which apparatus 10 is located. Employees may use other systems (not shown) to implement these functionalities. By way of non-limiting example, a user may fund their account by providing cash (or their credit card) to an employee who may use an external system to verify the user's credit card and to record the deposit into the user's account. In some embodiments which comprise only remote interface units 14, some of the hardware of main apparatus 12 may be separately provided and shared by remote interface units 14. By way of non-limiting example, as discussed above, WAN interface 36 may be separate from main apparatus 12 and may be shared by remote interface units 14. As another non-limiting example, ID verifier 46, card reader 30, card coder/printer 28 and/or the like could be provided in a stand-alone unit separate from main apparatus 12 and could be used in an embodiment having only remote interface units 14.

In some embodiments, apparatus 10 may provide (through its various user interfaces) methods for permitting users to make “automatic” or “semi-automatic” wagers and/or for promoting such wagers. Such automatic or semi-automatic wagers may simplify the wagering process for beginning or unsophisticated users and/or users who are otherwise content to allow apparatus 10 to make some of their wagering decisions—e.g. where one more criteria associated with the pari-mutuel wager are selected on behalf of the user. For explanatory purposes and not by way of limitation, the exemplary case of horse racing is used in the description of methods and apparatus for effecting automatic or semi-automatic wagering without loss of generality. Horse racing is one example of a non-limiting type of event on which a pari-mutuel wager can be made on an outcome of the event. In general, the methods described herein could be used to effect automatic or semi-automatic wagering for other types of pari-mutuel wagers on other types of outcomes and/or on other types of events. In a basic form, a fully automatic wager could involve the user entering a wager amount and pushing a single “quick pick” button (or any other suitable input, such as a GUI input, a suitable text message or the like (e.g. the word “YES” or “OK”) communicated via remote interface unit 14, and/or the like) and then apparatus 10 (e.g. under the control of controller 16 of main apparatus 12 or under the control of controller 38 of remote interface unit 14) would select other parameters (or criteria) associated with one or more wagers and recommend (or promote) those wagers to a user as potential wagers for the user to select from. For a horse racing embodiment, such other parameters may include, by way of non-limiting example: the particular track at which a race is taking place; the particular race(s) taking place at the track; the particular type of wager (e.g. win, place, show, exacta, trifecta, etc.); the particular horse(s)/dog(s) for the wager; and/or the like. Without limitation, particulars such as the example particulars provided above may also, or alternatively, referred to as “criteria”. The user may then select and make one of the recommended wager(s) by pressing an OK button (or any other suitable input). In some embodiments, this second confirmatory step is not required and the wager may be automatically placed when the user presses the first “quick-pick” button.

In other forms, such automatic or semi-automatic wagers may be more sophisticated and may allow users to input certain wagering criteria while automating others. By way of non-limiting example, such user input criteria may include: wagers that follow an established and/or user-configurable handicapping strategy; wagers on horses that wear certain colors; wagers on horses that have previously won large or small amounts of money or some other thresholding criteria based on horse winnings; wagers based on the gender of the horses; wagers based on a horse's name; wagers based on an amount of time since the last time a horse won a race; wagers based on a horse's speed differentials over a previous number (e.g. three or five) races (e.g. whether the horse has been getting faster or slower over the previous number of races); wagers based on winning jockeys (e.g. a threshold winning percentage) provided that the odds for the corresponding horse and the corresponding race are greater than or less than an odds threshold; wagers based on winning jockeys or horses (e.g. a threshold winning percentage) given particular weather or track conditions (e.g. on rainy days, bet on jockeys or horses that have a history of winning on sloppy tracks); wagers that follow the handicapping strategy of another wagerer; wagers that permit the application of particular rules based on odds; and/or the like. Once these criteria are input by the user, apparatus 10 (under the control of controller 16) may automatically select other parameters (e.g. non-user supplied criteria) associated with one or more wagers and recommend those wagers to a user. The user may then select and make one of the recommended wager(s) by pressing an OK button (or any other suitable input). In some embodiments, the user may provide their input in more than one stage. For example, in a two horse wager, the user may input certain criteria (e.g. for the first race) in a first stage and then may be prompted to input additional criteria (e.g. for the second race) in a second stage. Particular embodiments of the invention provide methods for recommending automatic and/or semi-automatic wagers wherein apparatus 10 (or remote interface 14) is able to select particular track(s), particular race(s) and/or particular wager type(s) for recommending to the user.

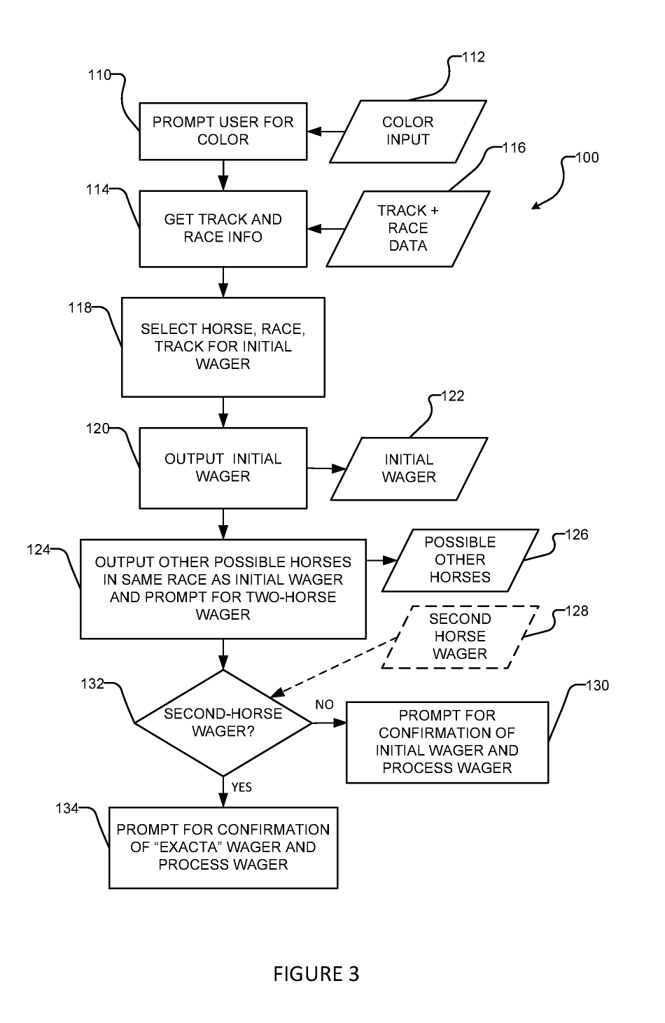

FIG. 3 is a schematic block diagram of a method 100 for a semi-automatic wagering according to a particular exemplary embodiment. Method 100 (and other automatic and semi-automatic wagering methods) may be implemented by controller 16 of apparatus 10 and/or by controller 32 of a remote interface unit 14. Data relating to horses, races, tracks and/or the like that is used in method 100 may be sourced by controller 16 from WAN 44 (e.g. the internet) or by any other suitable technique. In some embodiments, such data (or portions thereof) may be cached (e.g. at suitable time intervals) so that it is available to method 100 (and/or other similar methods) and to apparatus 10 (and/or remote interface devices 14). The semi-automatic wagering method 100 illustrated in the exemplary FIG. 3 embodiment may be referred to as the “color of money”, because it begins in block 110 by prompting a user for a particular horse color. The user provides color 112 via any suitable input mechanism. Method 100 then proceeds to block 114 which involves procuring track and race data 116. The procedures involved in block 114 and procuring track and race data 116 are described in more detail below. In some embodiments, track and race data 116 (or portions thereof) may be cached—e.g. from a previous iteration of method 100 or otherwise.

In block 118, method 100 involves selecting a track, a race and a horse for an initial wager 122. In the illustrated embodiment, initial wager 122 is a “win” type wager which involves a selected horse finishing first in a selected race at a selected track. The block 118 selected track and the block 118 selected race for initial wager 122 may be automatically determined by method 100 based on criteria discussed in more detail below. In the exemplary color or money method 100 illustrated in FIG. 3, the particular horse selected in block 118 for initial wager 122 may be based on color input 112 from user and the color worn by the various horses in the block 118 selected track and the block 118 selected race. For example, where the user's color input 112 is red, then the selected horse for initial wager 122 may be the horse wearing red in the block 118 selected track and the block 118 selected race.

Block 120 involves outputting the details of initial wager 122 selected in block 118 for display to the user. As discussed above, the details of initial wager 122 may comprise the block 118 selected track, the block 118 selected race and the block 118 selected horse. Although not expressly shown, in some embodiments, method 100 may jump from block 120 to block 130 which involves prompting the user for confirmation of initial wager 122. Assuming, in block 130, that the user confirms initial wager 112 then initial wager 122 is processed—e.g. as a “win” wager (or other one-horse wager) on the block 118 selected track, the block 118 selected race and the block 118 selected horse.

In the illustrated embodiment, however, method 100 does not jump from block 120 to block 130 and instead proceeds from block 120 to block 124. Block 124 involves outputting information 126 about one or more other horses in the block 118 selected race and prompting the user to see if the user might be interested in selecting another horse in the block 118 selected race for the purpose of making a two-horse wager (e.g. making the wager an “exacta” wager involving one horse to win and a second horse to place). Block 124 may involve outputting the particulars 126 of one or more other horses in the block 118 selected race. Such particulars 126 may include, by way of non-limiting example: the horse name, the horse color, the so-called “morning line odds” on the horse, an instantaneous approximation of the current odds on the horse, the money that the horse has won in the past and/or other particulars.

A user may then optionally make a second-horse wager 128 on a second horse. Block 132 involves an inquiry into whether the user makes a second-horse wager 128. If the user does not make second-horse wager 128, then method 100 proceeds to block 130 which involves prompting for confirmation of initial wager 122 (e.g. as a one-horse wager) and, assuming confirmation is received, processing initial wager 122. If the user does make second-horse wager 128 (e.g. by selecting one of the other horses 126 output in block 124), then method 100 proceeds to block 134. Block 134 involves prompting the user for confirmation of the two-horse wager (e.g. an “exacta” wager involving the combination of initial one-horse wager 122 and second-horse wager 128). Assuming confirmation is received, block 134 also involves processing the two-horse wager. In some embodiments, block 134 can involve prompting the user to determine if the user would like to “box” their wager (e.g. to allow permutations of their initial wager 122 and second-horse wager 128) and processing the boxed wager. In some embodiments, block 134 can involve automatically determining that the two-horse wager is boxed. In some embodiments, method 100 can be modified, so that a user must make a multi-horse wager (or a boxed multi-horse wager). Such a modification could be made by removing block 130 and the block 132 NO output branch, for example.

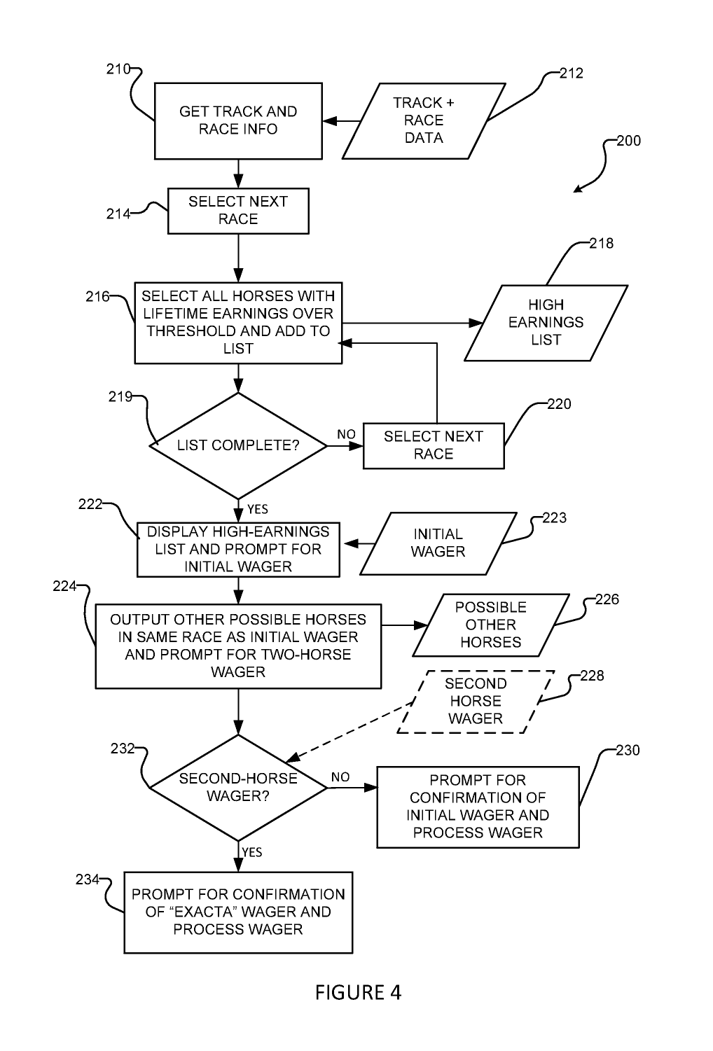

FIG. 4 is a schematic block diagram of a method 200 for a semi-automatic wagering according to another particular exemplary embodiment. Method 200 (and other automatic and semi-automatic wagering methods) may be implemented by controller 16 of apparatus 10 and/or by controller 32 of a remote interface unit 14. Data relating to horses, races, tracks and/or the like that is used in method 200 may be sourced by controller 16 or controller 32 from WAN 44 (e.g. the internet) and/or by any other suitable technique. In some embodiments, such data (or portions thereof) may be cached (e.g. at suitable time intervals) so that it is available to method 200 (and/or other similar methods) and to apparatus 10 (and/or remote interface devices 14). The semi-automatic wagering method 200 illustrated in the exemplary FIG. 4 embodiment may be referred to as the “bling daddy”, because it relates to ranking horses in upcoming races in accordance with the amount of money that the horses have won in the past. In the FIG. 4 method 200, the criteria of the user wanting a horse that is a historical high money winner is an example of user-wager information. Other types of user-wager information could be used in other embodiments, in a manner similar to how the horses' historical winnings are used in method 200. Method 200 begins in block 210 which involves procuring race and track data 212. The procedures involved in block 210 and procuring track and race data 212 are described in more detail below. In some embodiments, track and race data 212 (or portions thereof) may be cached—e.g. from a previous iteration of method 100 or otherwise. Method 200 then proceeds to block 214 which involves selecting a selected track and a selected race. The block 214 selected track and the block 214 selected race may be determined based on criteria discussed in more detail below.

Method 200 then proceeds to block 216 which involves selecting all of the horses in the block 214 selected race whose lifetime earnings are over a configurable threshold amount and adding any such horses to a high-earnings list 218. Once the block 216 selected horses from the first selected race are added to high-earnings list 218, method 200 proceeds to block 219 which involves an inquiry as to whether high-earnings list 218 is complete. If the block 219 inquiry determines that high-earnings list is not complete, then method 200 proceeds to block 220 (which involves selection of a new selected track and a new selected race based on track and race data 212) and back to block 216 (which involves selecting all of the horses in the block 220 selected race whose lifetime earnings are over a configurable threshold amount and adding any such horses to high-earnings list 218). After one or more iterations, the block 219 inquiry determines that high-earnings list 218 is sufficiently full (e.g. there are at least, or exactly, a threshold number of entries in the list). The block 219 inquiry may involve any suitable loop termination criteria, including, by way of non-limiting example: a threshold number of horses on high-earnings list 218; a threshold number of iterations of the block 216, 219, 220 loop; a block 220 selected race being over a threshold time into the future; a temporal proximity of one or more of the races on high-earnings list 218, combinations of the foregoing; and/or the like.

When the block 219 inquiry determines that high-earnings list 218 is complete, then method 200 proceeds to block 222 which involves displaying high-earnings list 218 and prompting the user for an initial wager 223 from among the horses on high-earnings list 218. Displaying high-earnings list 218 may involve displaying particulars, such as, by way of non-limiting example for each horse on the list: the horse's actual lifetime earnings, the track and the time of the race that the horse is involved in, the horse's name, the horse's color, the so-called “morning line odds” on the horse, an instantaneous approximation of the current odds on the horse and/or other particulars. The user may then make a selection from the displayed high-earnings list 218 for initial wager 223.

Although not expressly shown, in some embodiments, method 200 may jump from block 222 to block 230 which involves prompting the user for confirmation of initial wager 223. Assuming, in block 230, that the user confirms initial wager 223 then initial wager 223 is processed—e.g. as a “win” wager (or some other one-horse wager) on the user's selected horse from the high-earnings list 218 displayed in block 222.

In the illustrated embodiment, however, method 200 does not jump from block 222 to block 230 and instead proceeds from block 222 to block 224. Blocks 224, 230, 232 and 234 may be substantially similar to blocks 124, 130, 132 and 134 of method 100 described above and data 226, 228 may be substantially analogous to data 226, 228 of method 100 described above. Like method 100 described above, these aspects of method 200 may be implemented and modified to prompt a user to turn initial (one-horse) wager 223 into an multi-horse wager.

As discussed above, the criteria of the user wanting a horse that is a historical high money winner is merely an example of user-wager information which may be used to filter wagering opportunities that are presented to the user or which may be used to filter events that are added to the ranking list. In other embodiments, user's may provide other types of user-wager information (e.g. jockey's wining percentage, odds thresholds, track conditions, and/or the like).

Methods 100, 200 and other methods for automatic and semi-automatic wagering take some of the wagering decisions out of the hands of the user. These wagering decisions can instead be made automatically by apparatus 10, methods 100, 200 and/or similar automatic and semi-automatic wagering methods. The ability to make these types of wagering decisions on behalf of users can be advantageous for the house (e.g. the proprietor of wagering apparatus 10, the venue in which wagering apparatus 10 is located and/or the like). The ability to make these types of wagering decisions on behalf of users can be particularly advantageous where the wagering decisions involve the selection of a particular track for a wager, the selection of a particular race for a wager and/or the selection of particular wager type for a particular wager. These advantages are explained in more detail below.

As discussed above, pari-mutuel wagering involves the removal of certain funds (the takeout) from a pool of wagered money (the handle) prior to paying out the winning bets. In some jurisdictions, the maximum takeout rate (the total takeout as a percentage of the handle) is legislated, although this is not necessary. Typically, the takeout rate for a single horse wager (i.e. win, place or show) is less than the takeout rate for a two-horse wager and the takeout rate for a two-horse wager is less than the takeout rate for a three-horse wager, etc. The takeout represents the total amount that can be divided among all of the stakeholders involved in creating the wagering opportunity. In traditional OTB circumstances, such stakeholders may include, without limitation: any regulatory authorities (e.g. taxes levied by governments); content providers (e.g. the proprietors of the tracks at which races are held and the owners of winning horses); tote providers; optional charities (which may be mandated in some jurisdictions); statistics providers; and OTB proprietors. In circumstances where apparatus 10 is employed, the OTB proprietor stakeholder may be replaced by one or more of the proprietor of wagering apparatus 10 and/or the proprietor of the venue in which apparatus 10 is located, and/or the like.

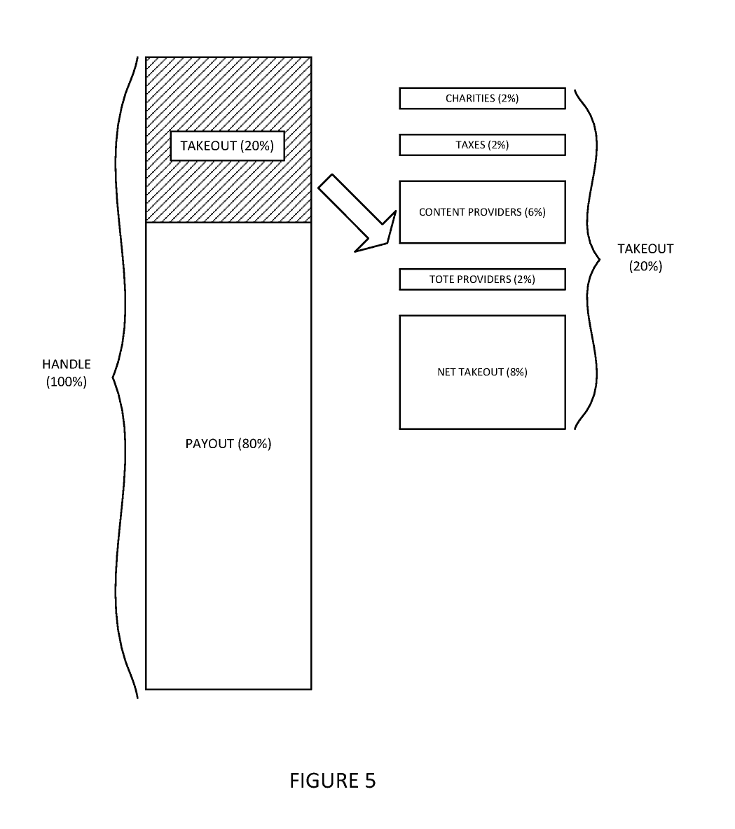

FIG. 5 is a schematic depiction of a typical scenario, where the payout represents 80% of the handle and the takeout represents 20% of the handle. In the illustrated embodiment, of the 20% takeout, 2% of the handle goes to charities, 2% of the handle goes to taxes, 2% of the handle goes to tote providers and 6% of the handle goes to the content providers. In the illustrated embodiment, after all of these other stakeholders are paid, the “net takeout” available for the house is 8%. It will be appreciated that FIG. 5 is merely exemplary and that there may be additional or fewer stakeholders that must be paid out of the total takeout before the net takeout is determined and that the total takeout rate and the takeout rates of each stakeholder may vary.

The net takeout can vary from track to track (e.g. content provider to content provider), from race to race and from wager type to wager type. For example, the net takeout can vary from track to track (content provider to content provider) because a particular track may demand a relatively high percentage of the handle to permit access to their content (e.g. to permit wagering on races held at their track, to permit access to video feeds of the races taking place at their track and/or the like), whereas another particular track may demand a lower percentage of the handle. An example of how the net takeout can vary from race to race is that the purse for a particular high profile race may be relatively large and consequently a track may demand a relatively high percentage of the handle for the high-purse race, whereas the purse for a relatively low profile race taking place at the same track may be relatively low and consequently the same track may demand a relatively low percentage of the handle for the low-purse race. An example of how the net takeout can vary from wager type to wager type was mentioned briefly above—i.e. a two-horse wager typically has a higher total (and net) takeout rate than a single horse race and a three-horse race typically has a higher total (and net) takeout rate than a two-horse race. Generally, the total takeout rates are higher for wager types involving a larger number of horses. Consequently, the net takeout rates may vary in a similar manner.

Based on the foregoing, it will be appreciated that all other things being equal, tracks, events (e.g. races) and wagers that yield a higher net takeout rate may be relatively more profitable for the house. Particular embodiments of the systems, apparatus and methods described herein involve attempting to recommend or promote wagers that involve relatively high net takeout rates and correspondingly high potential profits for the house. Such systems, apparatus and methods can take advantage of automatic and/or semi-automatic wagers where a user permits the system, apparatus or methods to select and/or promote the selection of the track(s), the race(s) and/or wager type(s).

As discussed above, information about tracks, events (e.g. races) and horses is available to apparatus 10 via WAN network 44 (e.g. the internet). Some embodiments involve using this available data to determine a ranking of events (e.g. a ranked list of races) occurring within a particular temporal “ranking window”. The temporal ranking window may be configurable. By way of non-limiting example, the temporal ranking window may be within an hour from the present or within two hours from the present. In currently preferred embodiments, the ranking criteria used to generate a ranked list of races comprise at least: the time of a particular race (relative to the present time); and the net takeout rate for at least one wager type for the particular race. However, the ranking criteria are not limited to these criteria and can be based on any suitable criteria, such as by way of non-limiting example: purse of the particular race; geographical proximity of the particular race to the location of apparatus 10; nationality of the horses in the particular race; colors worn by the jockeys in the particular race, the gender of the horses in the particular race and/or the like.

In accordance with one particular embodiment, a metric may be assigned to each ranking criterion and then the ranking criteria may be combined using a linear combination by assigning configurable weights to each ranking criterion. For example, the ranking score Rᵢ of a particular race I may be provided according to:

Rᵢ=aAᵢ+bBᵢ+cCᵢ+ . . . (1)

where: the capital letters A, B, C . . . represent the various ranking criteria; the subscripted capital letters Aᵢ, Bᵢ, Cᵢ . . . represent the metrics for the i^{th} race of the various ranking criteria A, B, C . . . ; and the lower case letters a, b, c . . . represent the weighting coefficients associated with the various ranking criteria A, B, C . . . .

In one example embodiment: the ranking criterion A represents a ranking criterion dependent on the net takeout rate of a race and ranking criterion B represents a ranking criterion dependent on the time until the race. To maximize profit derived from apparatus 10, it is desirable to have high net takeout rates and frequent bets. Accordingly, all other things being equal, races that have higher net takeout rates should be ranked higher than races that have lower net takeout rates. Similarly, all other things being equal, races that happen relatively soon should be ranked higher than races that happen a long way into the future. In one example embodiment: the metric Aᵢ associated with the ranking criterion A represents a decimal value for the net takeout rate for the i^{th} race (e.g. where the net takeout rate for a particular i^{th} race is 11.23%, then Aᵢ may be set to Aᵢ=0.1123); and the metric Bᵢ associated with the ranking criterion B represents the inverse of the time until the i^{th} race (e.g. where the time tᵢ until the i^{th} race is tᵢ=8 minutes, then Bᵢ may be set to Bᵢ=⅛=0.325). The individual coefficients a, b, c, . . . selected for the equation (1) ranking score may be configurable and may be determined by suitable experiment or simulation and may be adjusted from time to time. In some embodiments, the individual coefficients a, b, c, . . . are greater than zero. In other embodiments, the negative impact of temporally distant races could be achieved by setting the metric Bᵢ to be equal to the time until the i^{th} race and then selecting the coefficient b to have a value less than zero. Similarly, the negative impact of other criteria could be represented in the equation (1) formula by assigning the metric to be an inverse of the criteria or by selecting a negative coefficient. In some embodiments, the coefficients a, b, c, . . . may be empirically selected to maximize aggregate net takeout per unit time.

As mentioned above, in some embodiments, other ranking criteria may be taken into account in the equation (1) ranking score. While these ranking criteria should be understood to include any suitable criteria, in one embodiment, the ranking criterion C may relate to the proximity of particular race to the venue in which apparatus 10 is located. In some circumstances, one may want a positive correlation between the ranking score of a race and the proximity of the race—e.g. such that races happening closer receive relatively high rankings. In some circumstances, one may want to have a negative correlation between the ranking score of a race and the proximity of the race—e.g. such that users are encouraged to attend the track to bet on a race rather than bet on the race using apparatus 10 at an off track location. Depending on the circumstance, one may design a suitable metric or use a suitable coefficient to account for the proximity criterion C.

In some embodiments, the metrics associated with particular ranking criteria may be discretized or “binned”. By way of non-limiting example, in some embodiments, all races occurring in a time less than 3 minutes away may be categorized into a particular bin and assigned a corresponding particular metric, all races occurring in a time between 3 minutes and 5 minutes away may be categorized into a second bin and assigned a different second metric, all races between 5 and 10 minutes away may be categorized into a third bin an assigned a third metric and so on. In this example, the time (relative to the current time) is used as a binning criterion which defines the bins and orders the bins according to a bin rank order (e.g. where events occurring sooner are in higher ranked bins and events occurring further out in time are in lower ranked bins). In other embodiments, other discretization or binning criteria (e.g. net takeout rate, geographical event proximity and/or the like) could be used to create other bin rank orders. In some embodiments, ranking criteria may be applied to individual events within a bin to determine a bin ranking (i.e. of events within a bin). A ranked list may then be created by concatenating the bin rankings of the bins according to the bin rank order.

After calculating a ranking score for all of the available events (e.g. races) in the temporal ranking window, the events may be sorted into a ranking of events (e.g. a ranked list of races). In accordance with particular embodiments, this ranked list of races may be provided to the methods for automatic or semi-automatic wagering and used to help select potential wagers for recommendation/promotion to users. For example, in the case of method 100 (FIG. 3), the ranked list of races may be provided as track and race data 116 which is procured in block 114. Also, block 118 of method 100 may involve selecting the block 118 selected race and the block 118 selected track to be the race and track of the top ranking race in the ranked list of races. As another example, in the case of method 200 (FIG. 4), the ranked list of races may be provided as track and race data 212 and the selection of the “next” race in blocks 214 and 220 may involve, in each iteration, selecting the next highest ranking race from the ranked list of races. As a further example, a selection of the top-ranking races may be shown (e.g. simultaneously) to the user, such as in a list format, with the top ranking race at the beginning (or top of the list) and lower-ranked races listed afterwards. It will be appreciated that the user may be presented with a portion of the ranked list of events—e.g. a top threshold number of events or only events that have above a suitable ranking score Rᵢ.

It will be appreciated by those skilled in the art that the illustrated example methods 100, 200 of FIGS. 3 and 4 are merely examples of methods for automatic or semi-automatic wagering that could take advantage of a ranked list of races to maximize profits generated through apparatus 10. Aspects of the invention should be understood to include any suitable methods of automatic or semi-automatic wagering that allow the selection of races and/or tracks by someone other than the user, so that they may take advantage of a ranked list of races (e.g. this selection of races or tracks (by someone other than the user) may be based on the ranked list of races). The above-discussed techniques for generating the ranked list of races are not exhaustive. Other techniques could be used to generate the ranked list of races. In particular embodiments, such other techniques are also based (at least in part) on the net takeout rate and the time of the race (relative to the current time).

As discussed above, the net takeout rate may vary with the type of wager placed (e.g. one-horse wager, two-horse wager, or three-horse wager). Accordingly, in some embodiments, it may be desirable to determine different ranked lists of races for different wager types to account for these different net takeout rates. Methods 100, 200 of the illustrated embodiments (FIGS. 3 and 4) permit users to select between single horse wagers and multi-horse wagers. The ability of users to select between single-horse wagers and multi-horse wagers could be an issue for house profit maximization in cases where the ranked list of single horse wagers differed from the ranked lists of two-horse, three-horse and other multi-horse wagers. Typically, this is unlikely to be an issue because the net takeout rates typically increase with the number of horses associated with a wager and so the relative rankings of the one-horse and multi-horse wagers are unlikely to change significantly. However, if this was considered to be an issue, then it could be handled by modifying the illustrated methods (as discussed above) to force the user into a particular type of wager (e.g. an exacta wager) such that a single ranked list of races could be used for the particular type of wager. Alternatively, this issue could be handled by modifying the illustrated methods to force a user to elect a type of wager prior to picking the initial wager (e.g. forcing the user to pick between a single horse wager and a particular type of multi-horse wager at the outset of the methods) such that a single ranked list of races could be used for the methods based on the user-selected type of wager.

In other embodiments, systems, methods and apparatus make use of techniques other than ranked lists of races in effort to recommend/promote wagers that involve relatively high net takeout rates and correspondingly high potential profits for the house. Such systems, apparatus and methods can also take advantage of automatic and/or semi-automatic wagers where a user permits the system, apparatus or methods to select and/or promote the selection of the track(s), the race(s) and/or wager type(s).

As discussed above, which events are selected by apparatus 10 to be wagered upon or to be promoted to a user to be selected from are based on a ranking of events. The ranking of events may provide one or more outcomes; for example, it may sort ranked events according to ranked criteria, as discussed above, it may include or exclude events according to particulars or criteria such as net takeout rates (as is discussed in greater detail below), it may be limited to a certain number of events (e.g. a single event, selected for the user; enough events to fill a “page” of a user interface; enough events to fill multiple “pages” of the user interface; a soft limit of at least 10 events; a hard limit of no more than 100 events; etc.), and/or it may be otherwise structured, constructed, restricted, and/or modified to provide particular outcomes. For example, an indication that the user wishes to make a “colour of money” wager may result in the ranking of events being composed entirely of races with horses wearing red; horses wearing read is an outcome of the ranking. As another example, the apparatus 10 may be configured to avoid promoting events with less than a threshold net takeout rate (as discussed below), in which case exceeding the threshold net takeout rate may be an outcome of the ranking.

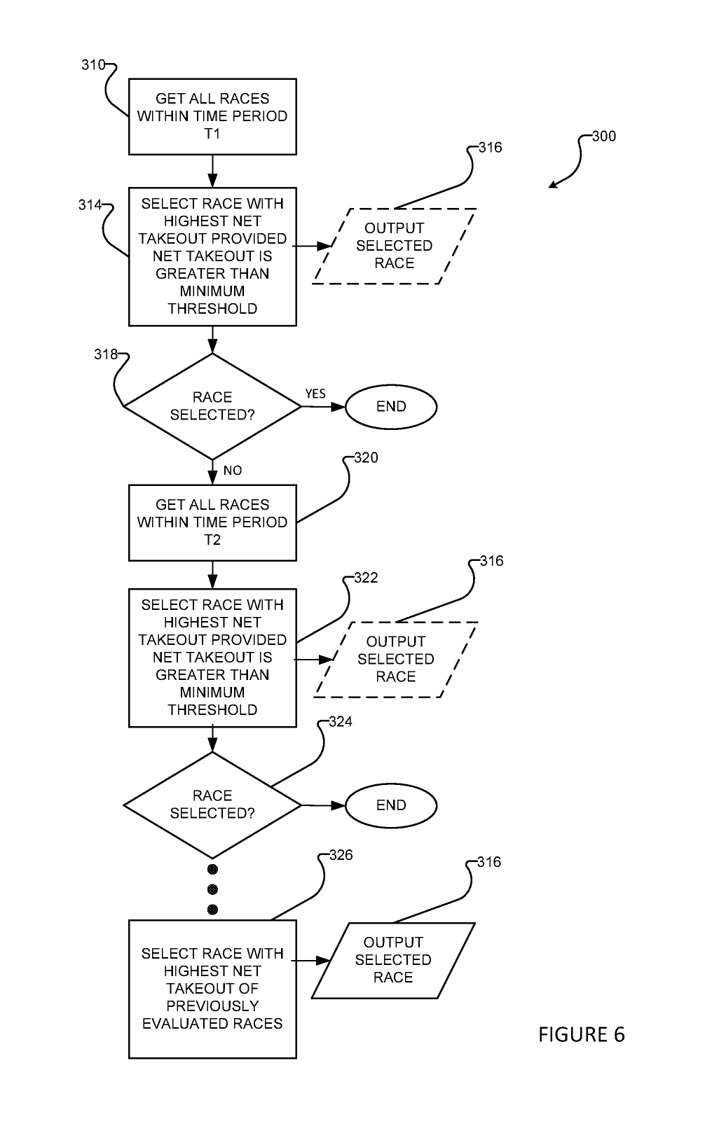

As discussed above, information about tracks, races and horses is available to apparatus 10 via WAN network 44 (e.g. the internet). FIG. 6 schematically depicts a method 300 for evaluating track and race data and for selecting one particular race according to a particular embodiment. By way of non-limiting example, method 300 may be used in block 118 of method 100 (FIG. 3) where it is desired to select one selected race at a corresponding selected track. Method 300 begins in block 310 which involves procuring the race data for all the races (at all the available tracks) within a first temporal period T₁ away from the current time. For example, T₁ might be set to T₁=3 minutes and block 310 may involve procuring data for all the races (at all the available tracks) in the next 3 minutes. Method 300 then proceeds to block 314 which involves selecting the race with the highest net takeout rate (of the group of races occurring within the T₁ time period) and optionally outputting that race as the selected race 316. This selected race 316 could be the selected race (and the corresponding selected track) for block 118 of method 100. Block 314 may additionally or alternatively involve checking to see if the race with the highest net takeout rate (of the group of races occurring within the T₁ time period) has a minimum threshold net takeout rate. If the race does meet this minimum threshold net takeout rate, then method 300 proceeds through the YES path of the block 318 inquiry and ends with the output of selected race 316. On the other hand, if the race does not meet this minimum threshold net takeout rate, then method 300 proceeds through the NO path of the block 318 inquiry to block 320 without outputting a selected race 316.

Blocks 320, 322 and 324 may be substantially similar to blocks 310, 314 and 318 except that blocks 320, 322 and 324 involve a time period T₂, where T₂>T₁. For example, if T₁ is set to T₁=3 minutes, then T₂ might be set to T₂=5 minutes. In other respects, blocks 320, 322 and 324 may be identical to blocks 310, 314 and 318. If a suitable race 316 is not output from block 322, then method 300 may perform any suitable number of iterations of blocks having functionality similar to blocks 320, 322 and 324, with each iteration considering a larger temporal window into the future. Eventually, if no race is selected after several iterations of blocks similar to blocks 320, 322, 324, then method 300 may end up in block 326 where it selects the race with the highest net takeout rate of the previously selected races to be selected race 316. Whenever it is selected, selected race 316 could be the selected race (and the corresponding selected track) for block 118 of method 100.

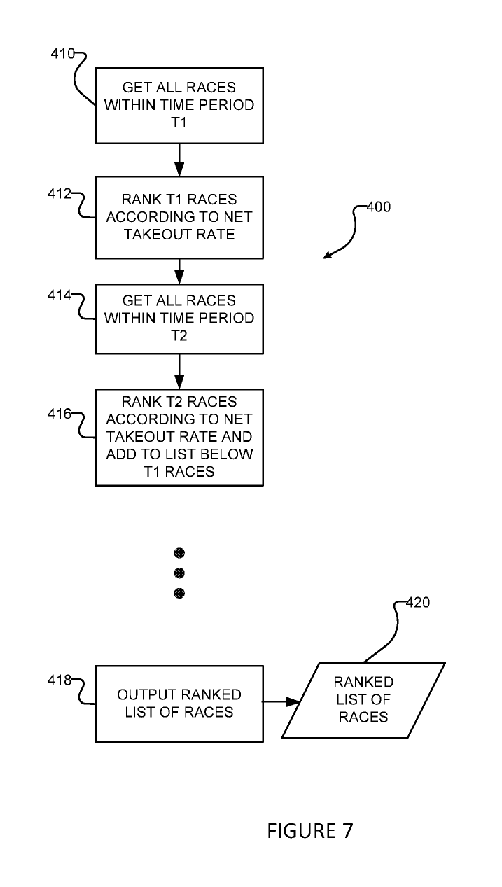

FIG. 7 schematically depicts a method 400 for evaluating track and race data and for generating a ranked list of races according to another embodiment. By way of non-limiting example, the method 400 ranked list of races may be used in method 100 (FIG. 3, block 118) where it is desired to select one particular race at one particular track and/or method 200 (FIG. 4) where it is optionally desired to have more than one particular race for a user to select between. Method 400 commences in block 410 which involves procuring the race data for all the races within a first temporal period T₁ away from the current time. For example, T₁ might be set to T₁=3 minutes and block 410 may involve procuring data for all the races in the next 3 minutes. Method 400 then proceeds to block 412 which involves ranking the races (within the T₁ period) according to their net takeout rates and then adding them to a list. Method 400 then proceeds to block 414 which involves procuring the race data for all the races within a first temporal period T₂ away from the current time, where T₂>T₁. For example, T₂ might be set to T₂=5 minutes and block 414 may involve procuring data for all the races in the time between T₁=3 minutes and T₂=5 minutes. Method 400 then proceeds to block 416 which involves ranking the block 414 races in the time period between T₁ and T₂ according to their net takeout rates and then adding these to the ranked list behind the races added to the list in block 412 (e.g. concatenating the block 416 ranked list onto the end of the block 412 ranked list). Method 400 may involve repeating blocks similar to blocks 410, 412 and to blocks 414, 416 for successive windows of time until a stop criteria (e.g. a configurable temporal ranking window, a configurable list length and/or the like) is met. By way of example and not limitation, the configurable temporal ranking window may be 1 hour into the future and/or the configurable list length may be 20 races. Method 400 eventually reach block 418, where it outputs a ranked list of races 420. The ranked list of races may be used by method 200 as track and race data 212—i.e. in the same way that method 200 might use the ranked list of races ranked in accordance with equation (1). The ranked list of races may be used by method 100 in block 118 to automatically select the top ranked race to be the automatically selected race (and the corresponding automatically selected track).

It will be appreciated by those skilled in the art that the illustrated example methods 100, 200 of FIGS. 3 and 4 are merely examples of methods for automatic or semi-automatic wagering that could take advantage of a ranked list of races (or one or more top ranked race(s)) to maximize profits generated through apparatus 10. Aspects of the invention should be understood to include any suitable embodiments that allow the selection or recommendation of races and/or tracks by someone other than the user, so that they may take advantage of a ranked list of races (or one or more top ranked race(s)). In particular embodiments, the user may be able to create and use user-configurable handicapping strategies. Such handicapping strategies may be envisaged to use any available information about horses, tracks, wagers, morning line odds, instantaneous odds or the like. Non-limiting examples of user-configurable handicapping strategies include: restricting initial wagers (or all wagers) to grey horses from Ireland; restricting initial wagers (or all wagers) to horses whose average race time is under 58 seconds and whose average final furlong time is less than 15 seconds and who have won at least once on a sloppy track; restricting initial wagers (or all wagers) to jockeys that have won more than three races; and/or the like.

Ranked lists of races of the type described herein could be used together with such handicapping strategies. Where such handicapping strategies allow the selection or recommendation of races and/or tracks by someone other than the user, so that they may take advantage of ranked lists of races of the type described herein, such handicapping strategies (whether user-configurable or configured by apparatus 10) should be considered to be automatic or semi-automatic wagering. Such handicapping strategies may involve the selection of a particular race (as is the case for the color of money example of FIG. 3). For example, if the handicapping strategy is grey horses from Ireland, then grey horses from Ireland may take the place of color input 112 and block 118 may involve selecting a particular track, race and horse for recommending as an initial wager 122 output in block 120. Such handicapping strategies may involve the display of a list of potential wagers for the user (as is the case for the bling daddy example of FIG. 4). For example, if the handicapping strategy is grey horses from Ireland, then the high-earnings list 218 may be replaced with a grey-horses-from-Ireland list and the block 216 process of selecting horses with lifetime earnings over a threshold amount may be replaced with selecting grey horses from Ireland.

In some embodiments, handicapping strategies (user configurable or configured by apparatus 10) may influence the ranking formulae. By way of example, a user could provide some levels of preferences (e.g. preferences ranked on a scale of 1-5) and such preferences could be incorporated into the ranking formula—e.g. into coefficients in equation (1) above or into metrics in equation (1) above. For example, a user could indicate that they prefer horses with a jockey that has won at least three previous races with a preference level 5 (i.e. a strong preference) and they prefer horse running under the color red with a preference level 3 (i.e. a mild preference). The weighting coefficients and/or metrics of the ranking formula (e.g. equation (1)) could be based, in part, on these preference levels.

In one particular embodiment of automatic or semi-automatic wagering, a user could indicate that they want to place wagers that are the same (except possibly for the amount wagered) as an “expert”. Such an “expert” could be an experienced handicapper and his/her wagers could be published so that a user can decide whether they want to place the same wagers as the “expert”. In some embodiments, the expert could be limited (e.g. by agreement with the house) to placing wagers that have a minimum net takeout rate or otherwise limited to placing wagers from among those wagers at the top of a ranked list of races (e.g. only a top threshold number of races or only races that have above a suitable ranking score Rᵢ). In some embodiments, a ranked list of wagers could be created based at least in part on net takeout rate and temporal proximity and could be limited to wagers “recommended” by the expert. Such wagering along with an expert allows someone other than the user to select tracks, races and wagers. Where such wagering along with an expert takes advantage of ranked lists of races of the type described herein, such wagering along with an expert should be considered to be automatic or semi-automatic wagering. The expert need not be a true “expert” and can be the friend of a user or any other user.

Other non-limiting examples of suitable automatic or semi-automatic wagers include:
A “top jock” automated wagering scheme, where a monitoring system (e.g. which may be implemented by suitably configured software operating on controller 16 of apparatus 10, on controller 38 of remote interface unit 14 and/or on a controller of remote server 112) is used to observe conditions where a jockey having a winning percentage greater than a configurable threshold has current pari-mutuel odds for an upcoming race that are below a configurable odds threshold. When such a condition exists, the monitoring system could alert the user, who could then pace a wager using an OK button (or any other suitable input). In some embodiments, the wager could be automatically placed by the monitoring system and the user could be notified by a suitable message (e.g. text message to remote interface unit 14). In such an automated wagering scheme (or any other wagering scheme incorporating a similar monitoring system), the monitoring system could be configured to select only potential wagers from a ranked list of races (as described above) by, for example, selecting only from a top threshold number of races or selecting only races that have above a suitable ranking score R₁.
A “rain gain” automated wagering scheme, where a monitoring system (e.g. which may be implemented by suitably configured software operating on controller 16 of apparatus 10, on controller 38 of remote interface unit 14 and/or on a controller of remote server 112) is used to observe conditions where a jockey or a horse having a winning percentage greater than a configurable threshold for the current weather or track conditions at a particular track (e.g. sloppy conditions) has current pari-mutuel odds for an upcoming race that are below a configurable odds threshold. When such a condition exists, the monitoring system could alert the user, who could then pace a wager using an OK button (or any other suitable input). In some embodiments, the wager could be automatically placed by the monitoring system and the user could be notified by a suitable message (e.g. text message to remote interface unit 14). In such an automated wagering scheme (or any other wagering scheme incorporating a similar monitoring system), the monitoring system could be configured to select only potential wagers from a ranked list of races (as described above) by, for example, selecting only from a top threshold number of races or selecting only races that have above a suitable ranking score Rᵢ.
   It will be appreciated that these are merely examples of automatic and semi-automatic wagering schemes and there are a wide variety of schemes where a user permits one or more criteria associated with the pari-mutuel wager to be selected on behalf of the user. Any such automatic or semiautomatic wagering schemes could form part of the systems and methods described herein for selecting wagers that benefit the house (e.g. because they occur relatively soon after a current time and/or because they have relatively high net takeout rates).

As discussed above, the instantaneous odds of a pari-mutuel wager can change over time. In particular embodiments, a user may configure their wagering preferences to automatically place or cancel (or increase or decrease) wagers based on the changing odds (e.g. the odds changing from below an odds-based threshold to above the threshold or from above an odds-based threshold to below the threshold). For example, a user may cause a wager to be automatically placed or withdrawn (or increased or decreased) by way of a limit-odds wager—i.e. where the wager is automatically placed or withdrawn (or increased or decreased) provided that the odds are greater than or less than an odds-limit threshold, but their wager is automatically reversed if the odds transition past the odds-limit threshold. Similarly, a user may cause their wager to be automatically placed or withdrawn (or increased or decreased) based on a stop-odds wager—i.e. where the wager is automatically placed or withdrawn (or increased or decreased) if the odds transition past an odds-stop threshold. Similarly, a user may cause their wager to be automatically placed or withdrawn based on a stop-limit-odds wager. Such a stop-limit-odds wager involves an odds-stop threshold and an odds-limit threshold. Such a stop-limit-odds wager may take a number of forms. For example, a wager may be automatically placed if the odds transition past an odds-stop threshold and then automatically withdrawn if the odds transition past an odds-limit threshold. As another example, a wager may be automatically withdrawn if the odds transition past an odds-stop threshold and then automatically re-placed if the odds transition past an odds-limit threshold. As still another example, a wager may be automatically placed when the odds transition past an odds-stop threshold and then automatically increased or decreased if the odds transition past an odds-limit threshold. Automatic wagering involving such odds-based thresholds may be combined with other forms of handicapping. By way of non-limiting example, such automatic wagering based on odds-based thresholds may be limited to wagers on grey horses from Ireland or any other suitable handicapping strategy.

In some embodiments, users could be limited to using this functionality (i.e. automatic wagering based on odds-based thresholds) on races dictated by a ranked list of races which could take the form of any of the ranked lists described herein and which could be based, at least in part, on net takeout rate and temporal proximity. Where such wagering is limited to ranked list(s) of races or wagers, such wagers should be considered to be automatic or semi-automatic wagers.

In embodiments where handicapping strategies are user configurable or where any other parameters (e.g. automatic placement or withdrawal of wagers based odds-stop thresholds or odds-stop-limit thresholds) of the methods described above are user-configurable, then a particular user's preferences may be recorded by system 10, so that they do not have to be re-entered for each wager.

Certain implementations of the invention comprise computer processors which execute software instructions which cause the processors to perform one or more methods of the invention. For example, the methods described herein may be implemented by one or more processors which execute software instructions which cause the processor to perform these methods. Such software instructions may be retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

While a number of exemplary aspects and embodiments are discussed herein, those of skill in the art will recognize certain modifications, permutations, additions and sub-combinations thereof. For example:
The above-discussed embodiments primarily describe horse racing, which is merely an example of an event where a pari-mutuel style wager may be placed on an outcome of the event. It will be appreciated that the above-described methods, systems and apparatus could be similarly applied to dog racing or other forms of racing where pari-mutuel wagering is performed or, more generally, to any type of event on which a pari-mutuel wager can be placed on an outcome of the event. By way of non-limiting example, the methods, systems and apparatus described herein could be used for wagering in connection with motor car races, outcomes associated with sporting games or events (such as, by way of non-limiting example, who will score the next goal or touchdown, whether a particular team will score more than X points in a game, whether a particular team will concede more than Y turnovers in a game and/or the like), the outcomes of democratic elections, the results of a company's quarterly earnings release, and other binary outcomes determined by a third party event that the user normally has no influence over.
Some of the embodiments described above comprise generating a ranking of races within a temporal “ranking window”. In some embodiments, other “windows” or thresholds may be used to limit the extent of the ranked lists. By way of non-limiting example, in some embodiments such windows may include: a geographical window (e.g. ranking only races that occur in a geographical region); a race-type window (e.g. ranking only flat races or only thoroughbred races); and/or the like.
Some of the embodiments described above comprise using a linear ranking equation. It will be appreciated that other suitable ranking equations (linear or non-linear) could be used in the place of the linear equation described above. Currently, it is preferred that such ranking equations take into account at least: the time of a particular race (relative to the present time); and the net takeout rate for at least one wager type for the particular race. However, the ranking criteria are not limited to these criteria and these criteria may not be required for all ranking schemes.
Particular embodiments described herein involve creating ranked lists of races and/or wagers. Such ranked lists may be based, at least in part, or net takeout rate and temporal proximity. Some embodiments described herein involve displaying a list of potential races/wagers to a user. This is the case for the bling daddy example of FIG. 4. When a list of races/wagers is displayed to a user, the list may, but need not be, listed in the same order as the ranking. Furthermore, the information used to make the ranking need not be displayed or otherwise communicated to the user.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for placing pari-mutuel wagers, the method comprising:
providing a user with an opportunity to place a pari-mutuel wager in which one or more criteria associated with the pari-mutuel wager are selected on behalf of the user;
generating a ranking of events from among a plurality of potential events based on one or more ranking criteria associated with each event;
presenting to the user one or more potential wagers based on one or more outcomes of one or more top-ranked events from the ranking, a number of the one or more top-ranked events less than a number of the plurality of potential events; and
permitting the user to place the pari-mutuel wager based at least in part on an outcome of one of only the one or more top-ranked events;
wherein the one or more ranking criteria associated with each event comprise a ranking criterion based on a net takeout rate associated with the event.

2. A method according to claim 1 wherein the one or more ranking criteria associated with each event comprise a ranking criterion based on a time, relative to a current time, at which the event is scheduled to take place.

3. A method according to claim 1 wherein the one or more ranking criteria associated with each event comprise a ranking criterion based on a geographic proximity of the event to the user.

4. A method according to claim 1 comprising receiving as input a handicap preference from the user, wherein the one or more ranking criteria associated with each event comprise a ranking criterion based on the handicap preference.

5. A method according to claim 1 wherein the plurality of potential events are selected from among: horse races and dog races.

6. A method according to claim 1 wherein the one or more ranking criteria associated with each event comprise a ranking criterion based on a characteristic associated with a horse in a horse race.

7. A method according to claim 1 wherein the one or more ranking criteria associated with each event comprise a ranking criterion based on a characteristic associated with a jockey in a horse race.

8. A method according to claim 1 wherein the one or more ranking criteria associated with each event comprise a ranking criterion based on a characteristic associated with a dog in a dog race.

9. A method according to claim 1 wherein the one or more ranking criteria comprises a plurality of ranking criteria.

10. A method according to claim 9 wherein generating the ranking of events from among the plurality of potential events comprises generating a rank for each event based on a weighted combination of the plurality of ranking criteria.

11. A method according to claim 9 wherein generating the ranking of events from among the plurality of potential events comprises generating a rank for each event based on a linear combination of weighted values, each weighted value based on a ranking metric associated with a corresponding one of the ranking criteria for the event and a weighting coefficient associated with the corresponding one of the ranking criteria.

12. A method according to claim 1 comprising receiving, as input, user-wager information from the user; and wherein generating the ranking of events from among the plurality of potential events is based at least in part on the user-wager information.

13. A method according to claim 1 comprising receiving, as input, user-wager information from the user; and wherein presenting to the user one or more potential wagers based on one or more outcomes of the one or more top-ranked events from the ranking comprises presenting the user with only potential wagers based on one or more outcomes of the one or more top-ranked events that are in accordance with the user-wager information.

14. A method according to claim 1 comprising determining each event from among the plurality of potential events to belong to one of a plurality of bins based on evaluating a binning criterion for each event; and wherein generating the ranking of events from among the plurality of events comprises, for each of one or more bins from the plurality of bins, applying the ranking criteria to each event belonging to the bin to determine a bin ranking.

15. A method according to claim 14 comprising determining a bin rank order for the plurality of bins according to the binning criterion.

16. A method according to claim 15 wherein the binning criterion comprises a plurality of time ranges, relative to a current time, at which events are scheduled to take place.

17. A method according to claim 15 wherein generating the ranking of events from among the plurality of events comprises concatenating the bin rankings of the plurality of bins according to the bin rank order.

18. A method according to claim 15 wherein generating the ranking of events comprises determining eligible binned events one or more times, and determining eligible binned events comprises:
selecting a bin of the plurality of bins according to the bin ranking and according to a bin selection history;
generating a ranking of binned events belonging to the selected bin, each of the events belonging to the selected bin having a rank value corresponding to the event's ranking in the ranking of binned events;
determining a set of eligible events belonging to the selected bin, each event of the set of eligible events having a rank value greater than a predetermined rank value threshold; and
if the set of eligible events is non-empty, adding at least one event of the set of eligible events to the ranking of events.

19. A method according to claim 18 wherein determining eligible binned events one or more times comprises determining eligible binned events with a first selected bin and, if the number of events added to the rankings of events is less than a predetermined event number threshold, determining eligible binned events with a second selected bin, the first selected bin preceding the second selected bin in the bin rank order.

20. A method according to claim 18 wherein determining a ranking of events comprises, in response to determining that no event belonging to any bin of the plurality of bins has a rank value greater than the rank value threshold:
determining a second plurality of bins of events according to a second binning criterion; and
determining a ranking of events according to the second plurality of bins of events.

21. A method according to claim 18 wherein determining a ranking of events comprises, in response to determining that no event belonging to any bin of the plurality of bins has a rank value greater than the rank value threshold, selecting an event according to a selection criterion; and adding the selected event to the ranking of events.

22. A method according to claim 21 wherein the selection criterion is a net takeout rate.

23. A method according to claim 21 comprising obtaining a threshold criteria; and wherein presenting to the user one or more potential wagers based on one or more outcomes of the one or more top-ranked events from the ranking comprises applying the threshold criteria to the one or more potential wagers and presenting to the user only potential wagers that satisfy the threshold criteria.

24. A method according to claim 23 wherein the threshold criteria is based at least in part on a minimum net takeout rate.

25. A method according to claim 23 wherein the threshold criteria is based at least in part on user input.

26. A method according to claim 1 comprising:
receiving an initial wager selection from the user based on the outcome of one of the one or more top-ranked events;
presenting to the user one or more alternative wagers based on the initial wager selection;
providing the user with the opportunity to select one of the one or more alternative wagers as a final wager selection; and
placing the pari-mutuel wager according to the final wager selection.

27. A method according to claim 26 wherein the one or more alternative wagers comprises wagers associated with the same event as the initial wager selection.

28. A method according to claim 26 wherein the events are races, the initial wager selection is a one-racer wager and the final wager selection is a multi-racer wager.

29. A method according to claim 1 comprising permitting the user to place the pari-mutuel wager that matches a corresponding wager of a third party, wherein the third party is restricted to selecting wagers from among the one or more potential wagers based on the one or more outcomes of the one or more top-ranked events.

30. A method according to claim 1 comprising:
receiving an odds-based wagering preference from the user;
receiving updated odds on the pari-mutuel wager;
determining that the updated odds conflict with the odds-based wagering preference of the user; and
in response to determining that the updated odds conflict with the odds-based wagering preference of the user, changing the pari-mutuel wager.

31. A method according to claim 30 wherein changing the pari-mutuel wager comprises one of: placing the wager, cancelling the wager, increasing the wager and decreasing the wager.

32. A method according to claim 1 wherein generating the ranking of events comprises determining a top ranked event from among the plurality of potential events; presenting to the user the one or more potential wagers based on the one or more outcomes of the one or more top ranked events comprises presenting to the user one or more potential wagers based on one or more outcomes of the top ranked event; and permitting the user to place the pari-mutuel wager based at least in part on the outcome of one of only the one or more top-ranked events comprises permitting the user to place the pari-mutuel wager based at least in part on an outcome of only the top ranked event.

33. A method according to claim 1 wherein presenting to the user the one or more potential wagers based on the one or more outcomes of the one or more top ranked events comprises presenting to the user one or more potential wagers based on one or more outcomes of a top ranked event; and permitting the user to place the pari-mutuel wager based at least in part on the outcome of one of only the one or more top-ranked events comprises permitting the user to place the pari-mutuel wager based at least in part on an outcome of only the top ranked event.

34. A method according to claim 32 wherein the one or more ranking criteria associated with each event comprise a ranking criterion based on a net takeout rate associated with the event.

35. A method according to claim 34 wherein the one or more ranking criteria associated with each event comprise a ranking criterion based on a time, relative to the current time, at which the event is scheduled to take place.

36. A method according to claim 1 wherein the one or more ranking criteria associated with each event comprise a combination of a ranking criterion based on a net takeout rate associated with the event and a ranking criterion based on a time, relative to the current time, at which the event is scheduled to take place and wherein one or more particulars of the combination are empirically selected to maximize aggregate net takeout per unit time.

37. A method according to claim 1 wherein the plurality of potential events are selected from a set of events scheduled to occur within a temporal ranking window that extends to a threshold time in the future.

38. An apparatus for placing pari-mutuel wagers, the apparatus comprising a processor in communication with a display and a network, the processor configured to:
provide a user with an opportunity to place a pari-mutuel wager over the network in which one or more criteria associated with the pari-mutuel wager are selected on behalf of the user;
generate a ranking of events from among a plurality of potential events based on one or more ranking criteria associated with each event;
present on the display one or more potential wagers based on one or more outcomes of the one or more top-ranked events from the ranking, a number of the one or more top-ranked events less than a number of the plurality of potential events; and
permit the user to place the pari-mutuel wager based at least in part on an outcome of one of only the one or more top-ranked events;
wherein the one or more ranking criteria associated with each event comprise a ranking criterion based on a net takeout rate associated with the event.

39. A method for semi-automatically placing pari-mutuel wagers, the method comprising:
receiving a user identification from a user;
determining a stored value account associated with the user based on the user identification;
receiving a wager amount from the user;
determining a temporal ranking window based on a threshold time;
obtaining a set of events occurring within the temporal ranking window;
determining a ranked list of events by applying one or more ranking criteria to each event of the set of events;
displaying to the user one or more events according to the ranked list of events; and
in response to a user selection of a selected event from among the one or more events, placing a wager based on the selected event and the wager amount with funds from the stored value account.

40. A method for automatically placing pari-mutuel wagers, the method comprising:
receiving a user identification from a user;
determining a stored value account associated with the user based on the user identification;
receiving a wager amount from the user;
determining a temporal ranking window based on a threshold time;
obtaining a set of events occurring within the temporal ranking window;
determining a rank order on one or more of the events of the set of events based on one or more ranking criteria;
selecting a selected event based on the rank order;
placing a wager on the selected event with funds from the stored value account, the wager based on the wager amount.

41. An apparatus for placing pari-mutuel wagers, the apparatus comprising a processor in communication with a display and a network, the processor configured to:
receive a user identification;
determine a stored value account associated with the user based on the user identification;
receive a wager amount from the user;
determine a temporal ranking window based on a threshold time;
obtain, over the network, a set of events occurring within the temporal ranking window;
determine a ranked list of events by applying one or more ranking criteria to one or more events of the set of events;
display to the user one or more events according to the ranked list of events; and
in response to a user selection of a selected event from among the one or more events, place a wager based on the selected event and the wager amount with funds from the stored value account.

42. An apparatus for placing pari-mutuel wagers, the apparatus comprising a processor in communication with a display and a network, the processor configured to:
receive a user identification from a user;
determine a stored value account associated with the user based on the user identification;
receive a wager amount from the user;
determine a temporal ranking window based on a threshold time;
obtain a set of events occurring within the temporal ranking window;
determine a rank order on one or more of the events of the set of events based on one or more ranking criteria;
select a selected event based on the rank order;
place a wager on the selected event with funds from the stored value account, the wager based on the wager amount.
